(19) United States
(12) Patent Application Publication
(10) Pub. No.: US 2007/0282051 A1
(43) Pub. Date: Dec. 6, 2007

(54) INTERMEDIATE TRANSFER BELT AND ELECTROPHOTOGRAPHIC APPARATUS

(75) Inventor: AKIRA OKANO, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/757,100

(22) Filed: Jun. 1, 2007

(30) Foreign Application Priority Data
Jun. 6, 2006 (JP) 2006-157359
May 29, 2007 (JP) 2007-141407

(51) Int. Cl. G03G 15/20; C08K 3/08; C08K 3/04

(52) U.S. Cl. 524/495; 399/308; 524/439

(57) ABSTRACT

The present invention provides an intermediate transfer belt of a single layer made from a resin composition containing a crystalline thermoplastic resin and 5 parts by mass or more and 40 parts by mass or less of an conductive filler with respect to 100 parts by mass of the crystalline thermoplastic resin, wherein the surface hardness of the intermediate transfer belt is 0.25 GPa or higher and 0.60 GPa or lower when measured using a nanoindentation method; and an electrophotographic apparatus having the intermediate transfer belt.

### BACKGROUND OF THE INVENTION

1. Field of the Invention

The present invention relates to an intermediate transfer belt for use in an electrophotographic apparatus and an electrophotographic apparatus having such an intermediate transfer belt.

2. Description of the Related Art

An electrophotographic apparatus which can copy or print a full-color image has been put to practical use in recent years, as an image-forming apparatus of an electrophotographic system, namely, an electrophotographic apparatus. As for a system of transferring a full-color image onto a transfer material, the electrophotographic apparatus employs an intermediate transfer system which specifically includes the steps of: forming toner images made of several colors on an electrophotographic photosensitive member; sequentially transferring and superimposing the toner image onto an intermediate transfer member to form a synthesized toner image; and transferring the synthesized toner image onto the transfer material as a single unit.

An intermediate transfer member often used in the intermediate transfer system is an intermediate transfer member having an endless belt shape, namely, an intermediate transfer belt.

An intermediate transfer belt is suspended on two or more rollers (suspension rollers) in an electrophotographic apparatus, and is driven in a tensed state for a long period of time. For this reason, the intermediate transfer belt is required to have sufficient durability. The intermediate transfer belt can have both of tensile elasticity and bending resistance in particular, as mechanical characteristics. When the intermediate transfer belt has, for instance, excessively low tensile elasticity, the intermediate transfer belt causes distortion therein and lowers the durability of itself. In addition to this, the intermediate transfer belt causes the distortion and a color shift of a toner image transferred onto itself. On the other hand, when having a low level of bending resistance, the intermediate transfer belt causes rupture or cracking in itself.

The intermediate transfer belt also has preferably superior heat resistance and flame resistance, because a high voltage of 100 V to several kilovolts or higher is occasionally applied on the intermediate transfer belt.

For the above described reason, various intermediate transfer belts are proposed which employ a resin having both of heat resistance and flame resistance. For instance, Japanese Patent Application Laid-Open No. 2004-276434 discloses an intermediate transfer belt manufactured by extruding a polyphenylene sulfide (PPS) resin through a cylindrical die to mold it into a belt shape. In addition, Japanese Patent Application Laid-Open No. 2005-112942 discloses a semiconductive film which is manufactured by extruding a resin composition including a polyetheretherketone (PEEK) resin and an added conductive filler (carbon black) to mold it into a belt shape, and thereby has superior bending resistance specified in JIS P 8115.

Conventionally, it has been considered to be necessary to decrease the crystallinity of a resin composition, in order to improve the above described bending resistance of an intermediate transfer belt made from a resin composition containing a crystalline thermoplastic resin and a conductive filler.

However, when an intermediate transfer belt molded while keeping the crystallinity of a resin composition low is used in an electrophotographic apparatus that uses a two-component developer containing a magnetic carrier and a toner, the intermediate transfer belt easily forms a scratch on its surface due to the carrier, which is a problem. The scratch damages an electrophotographic photosensitive member which abuts on the intermediate transfer belt, and consequently causes an image defect.

In order to prevent the scratch due to the carrier, many intermediate transfer belts are proposed which have a bilayer structure comprising a substrate made from a resin composition containing a crystalline thermoplastic resin, and a high-hardness layer formed on the surface.

However, when an intermediate transfer belt has such a high-hardness layer formed thereon, the high-hardness layer needs to be a thin film so as not to deteriorate its bending resistance of a substrate, and accordingly has made an operation process complicated such as addition of thin film preparation step.

### SUMMARY OF THE INVENTION

An object of the present invention is to provide an intermediate transfer belt which has high surface hardness and excellent bending resistance, even though being a single-layered intermediate transfer belt made from a resin composition containing a crystalline thermoplastic resin and a conductive filler.

Another object of the present invention is to provide an electrophotographic apparatus having the intermediate transfer belt.

As a result of an extensive investigation, the present inventors have found that when an intermediate transfer belt has a surface hardness of 0.25 GPa or higher when measured according to an nanoindentation method, the intermediate transfer belt does not form a scratch on its surface due to a carrier, even though being a single-layered intermediate transfer belt made from a resin composition containing a crystalline thermoplastic resin and a conductive filler.

Specifically, the present invention provides an intermediate transfer belt of a single layer made from a resin composition containing a crystalline thermoplastic resin and 5 parts by mass or more and 40 parts by mass or less of a conductive filler with respect to 100 parts by mass of the crystalline thermoplastic resin, wherein the surface hardness of the intermediate transfer belt is 0.25 GPa or higher and 0.60 GPa or lower when measured using a nanoindentation method.

The present invention also provides an electrophotographic apparatus having the intermediate transfer belt.

Further features of the present invention will become apparent from the following description of exemplary embodiments with reference to the attached drawings.

### BRIEF DESCRIPTION OF THE DRAWINGS

FIG. 1 illustrates an example of S—N curve of a resin, which is obtained according to a method specified in JIS P 8115.

FIG. 2 illustrates S—N curve of a resin, which is obtained by using a converted stress value to be used in the present invention.

FIG. 3 is an explanatory drawing of a deformed state of a resin film when the resin film is bent.

FIG. 4 is a schematic view illustrating an example of a configuration of an image-forming apparatus which incorporates an intermediate transfer belt manufactured according to the present invention therein.

### DESCRIPTION OF THE EMBODIMENTS

An intermediate transfer belt according to the present invention uses, as described above, a resin composition (hereafter also referred to as “resin composition according to the present invention”) containing a crystalline thermoplastic resin and 5 parts by mass or more and 40 parts by mass or less of a conductive filler with respect to 100 parts by mass of the crystalline thermoplastic resin.

Various crystalline thermoplastic resins can be used for a resin composition according to the present invention. The crystalline thermoplastic resin means a thermoplastic resin having such a property that a polymer chain is regularly aligned at its melting point or lower, and tends to show a few cross-linking or branching structures. In the various crystalline thermoplastic resins, polyetheretherketone (hereafter also merely referred to as “PEEK”) can be ordinarily used. The PEEK is a crystallizable polymer but also has characteristics of an amorphous polymer, because the crystallinity can be moderately controlled by appropriately designing a molecular structure. Specifically, the PEEK has superior chemical resistance, fatigue resistance, toughness, abrasion resistance, slidability and heat resistance. The PEEK also has superior impact resistance and bending resistance. Furthermore, the PEEK shows high flame resistance, and besides, hardly produces smoke or an irritant gas when combusting.

General PEEK is a resin having a repeated structure unit shown in the following structural formula.

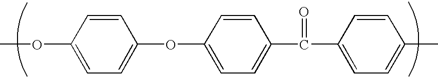

When using PEEK for the above described crystalline thermoplastic resin, the PEEK may be used singly, or in combination with other one or more PEEKs.

A representative PEEK among commercially available products includes “Victrex PEEK” series which is a trade name and is made by Victrex.

The PEEK which can be used in the present invention is not limited to the one having a repeated structure unit as shown in the above described structure formula, but may be modified one by various chemical compounds. For instance, siloxane-modified PEEK is disclosed in Japanese Patent No. 2639707.

A weight average molecular weight of a crystalline thermoplastic resin can be adjusted into melt viscosity in a range of 1.0×10² Pa·s to 1.0×10⁵ Pa·s.

A conductive filler which can be used in the present invention includes, for instance, a conductive carbon black, graphite powder, a metallic powder, and a whiskery metal oxide having the surface conductive-treated. Among those, the conductive carbon black can be ordinarily used because of having controllable volume resistivity and adequate mechanical properties.

A conductive carbon black includes, for instance, acetylene black, oil furnace black, thermal black and channel black. Among those, acetylene black and oil furnace black can be used. These conductive carbon blacks may be used singly, or in combination with other one or more conductive carbon blacks.

A conductive filler is contained in a resin composition according to the present invention in an amount of 5 parts by mass or more and 40 parts by mass or less with respect to 100 parts by mass of a crystalline thermoplastic resin, preferably 5 parts by mass or more and 30 parts by mass or less, and further preferably 6 parts by mass or more and 20 parts by mass or less. When the conductive filler is contained excessively in the resin composition, the intermediate transfer belt occasionally makes its volume resistivity too low, or lowers its mechanical properties. When the conductive filler is contained too little in the resin composition, the intermediate transfer belt occasionally makes its volume resistivity too high.

A resin composition according to the present invention can contain 50 parts by mass or less of an elastomer component with respect to 100 parts by total mass of PEEK and a conductive filler, so as to improve physical properties of an intermediate transfer belt according to the present invention.

The elastomer component includes: natural rubber; a butadiene polymer, a styrene-isoprene polymer, a butadiene-styrene copolymer and a hydrogenated substance thereof (including all of a random copolymer, a block copolymer and a graft copolymer); an isoprene polymer, a chlorobutadiene polymer, a butadiene-acrylonitrile copolymer, an isobutylene polymer, an isobutylene-butadiene copolymer, an isobutylene-isoprene copolymer, an acrylate polymer, an ethylene-propylene copolymer and an ethylene-propylene-diene copolymer; a thiokol rubber, a polysulfide rubber, a polyurethane rubber and a polyether rubber (such as polypropylene oxide); and epichlorohydrin rubber.

A resin composition according to the present invention can include one or more additives such as an oxidation inhibitor, a heat stabilizer, a heat age resistor, a weather-resisting agent, a plasticizer, a crystalline nucleating additive, a fluidity modifier, an ultraviolet absorber, a slip additive, a mold release agent; a coloring agent like a dye and a pigment; and a fire proofing agent and a fire retarding auxiliary.

An intermediate transfer belt according to the present invention has average thickness preferably in a range of 50 to 250 μm, more preferably in a range of 60 to 150 μm, and further preferably in a range of 70 to 110 μm. When the intermediate transfer belt is too thin, the thickness tends to be hardly uniform. On the other hand, when the intermediate transfer belt is too thick, the flexibility tends to be lowered.

An intermediate transfer belt according to the present invention can be semiconductive. Specifically, the intermediate transfer belt according to the present invention has volume resistivity preferably in a range of 1.0×10³ to 1.0×10¹⁴ Ωcm and more preferably in a range of 1.0×10⁵ to 1.0×10¹³ Ωcm. The intermediate transfer belt also can have a ratio of the surface resistivity to the volume resistivity (surface resistivity/volume resistivity) in a range of 1 to 1,000.

An intermediate transfer belt according to the present invention has a tensile elasticity preferably of 1.5 GPa or higher and more preferably of 2.0 GPa or higher, when measured according to JIS K 7113. On the other hand, the intermediate transfer belt can have the tensile elasticity of 4.0 GPa or lower, because when the intermediate transfer belt has too high tensile-elasticity, curling habit due to a suspension roller may remain in the intermediate transfer belt.

An intermediate transfer belt according to the present invention can have a surface hardness of 0.25 GPa or higher. On the other hand, the intermediate transfer belt has the surface hardness preferably of 0.60 GPa or lower, because when having too high surface hardness, the intermediate transfer belt may abrade various members which abut on the intermediate transfer belt. The surface hardness described in the above means the surface hardness measured by using a nanoindentation method. The hardness (H) measured by using the nanoindentation method can be converted to Vickers hardness by using an equation of H=0.01057 VHN (kg/mm²).

In the present invention, the measurement of the surface hardness according to the nanoindentation method used Nano Indenter XPW made by MTS Nano Instruments Co. as a measuring apparatus. The indenter used is Berkovich indenter. The indentation depth is set as 2 μm.

In order to increase the surface hardness of an intermediate transfer belt, it is essential only that the crystalline thermoplastic resin contained in the resin composition has high crystallinity. The degree of the crystallinity can be measured by subjecting the intermediate transfer belt to thermal analysis with the use of a differential scanning calorimetry (DSC). The crystalline thermoplastic resin in the present invention can have a peak of crystallization exothermic heat ΔH detected between 150° C. and 200° C. in an amount of less than 10 J/g, when subjected to the thermal analysis with the use of the differential scanning calorimetry (DSC).

The crystallization exothermic heat is measured in the present invention, by using a differential scanning calorimetry (DSC), and adjusting a heating rate to 5° C./min, a measurement-starting temperature to 100° C., a measurement-finishing temperature to 400° C., and a sample weight to 10 mg.

An intermediate transfer belt according to the present invention can have a fatigue limit stress of 30 MPa or higher and 150 MPa or lower, which is determined from the conversion stress shown in the following expression (1) and a determination of folding endurance (bending fatigue test) specified in JIS P 8115.

conversion stress=E×d/(4r+2d)+9.8M/(d×h) (1)

In the expression (1), d/(4r+2d) is 0.03 or less; E represents a Young's modulus of a sample with a film shape, which is collected from the intermediate transfer belt and is subjected to the measurement of the conversion stress; d represents a thickness of the sample; r represents a bending radius; M represents a load; and h represents a width of the sample.

In the present invention, the thickness of the sample d is the same as the thickness of the intermediate transfer belt to be measured and a width of the sample h is 15 mm. The length of the sample is 110 mm. The shape of the sample is reed shape. The load M is fixed at 1 kgf. If the bending radius r is set as 0.38 mm as specified in JIS P 8115, d/(4r+2d) may be more than 0.03. For example, when d is 0.1 mm as mentioned in the working examples below, d/(4r+2d) is about 0.06 which is more than 0.03. Accordingly, it is necessary to change properly the bending radius r in order to be d/(4r+2d)≦0.03 in accordance with a value of the sample thickness d.

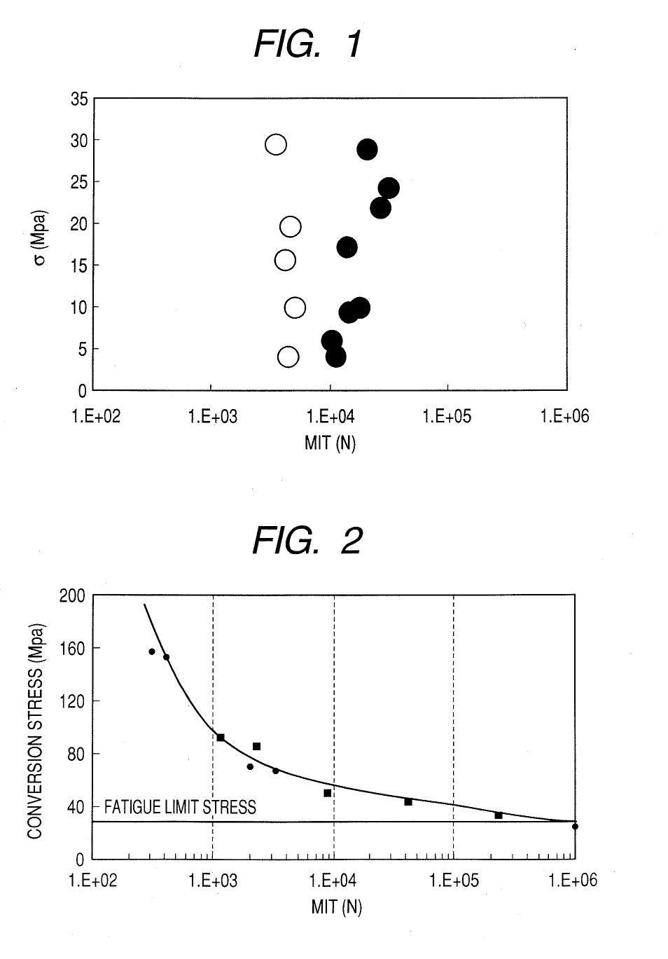

As for the above described determination of folding endurance (bending fatigue test), a method using a MIT testing method specified in JIS P 8115 has been well known. However, when an intermediate transfer belt is tested according to the method, an ideal stress-fatigue curve (S—N curve) is occasionally not drawn (FIG. 1), though the result depends on a type of a resin (crystalline thermoplastic resin) to be used in the intermediate transfer belt. This is because, in the above described MIT test, the radius (r) of a part to be bent is too small, so that a resin film receives an excessive bending stress when bent. In the above described MIT test, when a film-shaped sample made from a resin composition is subjected to the test, a bending stress of the resin is not considered. For this reason, in the present invention, MIT test specified in JIS P 8115 is employed as a determination of folding endurance (bending fatigue test) and the “conversion stress” (=bending stress+tensile stress) is used as a stress applied to the film-shaped sample in the test. By employing such constitution, an ideal S—N curve can be drawn (FIG. 2) on the film-shaped samples made from various resin compositions.

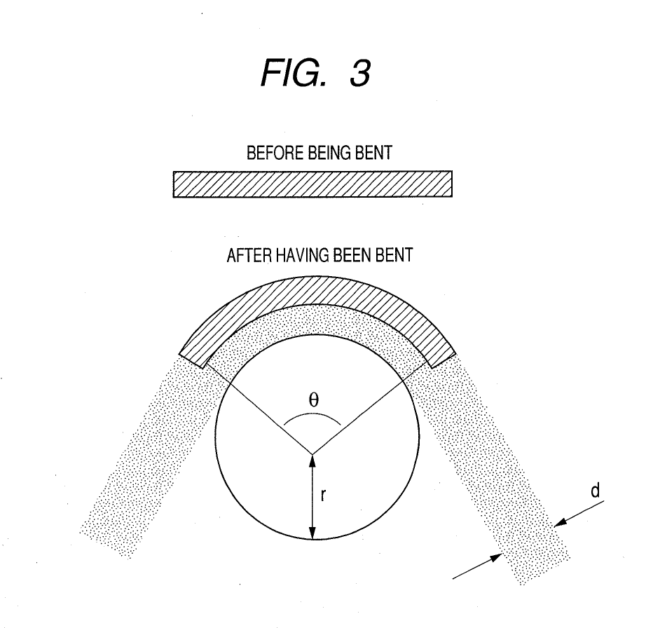

As is shown in FIG. 3, an external side with respect to the center of a thickness direction of a film-shaped sample is elongated by ΔL in a determination of folding endurance (bending fatigue test), so that a bending stress is generated in the sample. An elongation percentage of a resin when the resin is bent is determined by determining a difference between volumes in the outer side in a thickness direction than the center of the sample after having been bent and before being bent, and dividing the difference by the volume before being bent.

elongation percentage of resin film: (volume after having been bent−volume before being bent)/volume before being bent
volume before being bent: (θ/360)×2π(r+(d/2))×(d/2)×h
volume after having been bent: (θ/360)×(π(r+d)²−π(r+(d/2))²)×h
θ: bending angle, r: bending radius, d: thickness, h: width
elongation percentage of resin film when bent: d/(4r+2d)

Specifically, the film-shaped sample is forcefully elongated by (d/(4r+2d))×100 (%) in comparison with the state before being bent, while being bent. A bending stress generated when a resin is bent in a determination of folding endurance (bending fatigue test) is determined by multiplying a modulus of elasticity of the film-shaped sample by the elongation percentage when the sample has been bent. A tensile stress in the determination of folding endurance (bending fatigue test) can also be obtained by converting a load.

In the test, an elongation percentage of the above described film-shaped sample must be 3% or less by adjusting d and r, and more preferably 2% or less. When the elongation percentage is larger than 3%, the state of the sample exceeds an elasticity region of a normal resin film, and the sample may be evaluated in a plastically deformed state.

When an intermediate transfer belt is incorporated into an electrophotographic apparatus, a cross-directional edge part is prone to be bent more. The edge part is not deformed due to displacement but by generated stress. Accordingly, a material with a high modulus of elasticity has actually a different limit capable of being bent from that of a material with a low modulus of elasticity. For this reason, it is effective to calculate the fatigue limit stress based on an S—N curve obtained by using the conversion stress.

In the present invention, a fatigue limit stress value shall be defined as a lower limit of a conversion stress value when the breaking number exceeds 1,000,000 times in a determination of folding endurance (bending fatigue test) with the use of the above described film-shaped sample. An intermediate transfer belt having the fatigue limit stress value of 30 MPa or higher hardly causes breakage in the edge part even when the intermediate transfer belt is incorporated into an electrophotographic apparatus, and hardly causes a problem with mechanical durability. A usable intermediate transfer belt is assumed to have physical properties in ranges of less than 4 GPa for a modulus of elasticity and thicker than 50 μm for the thickness. Then, the fatigue limit stress would be 150 MPa at the maximum.

A method for manufacturing an intermediate transfer belt according to the present invention is not limited in particular, but any manufacturing method may be used. For instance, the method includes a process for manufacturing a seamless belt by connecting sheets (see Japanese Patent Application Laid-Open No. H8-187773 and the like), and a process for manufacturing a belt by extruding a resin into a cylinder through a cylindrical die (see Japanese Patent Application Laid-Open No. 2001-13801, Japanese Patent No. 02886350 and the like). The method may also include preparing a cylindrical tube containing amorphous PEEK, and subjecting it to a secondary treatment of enhancing crystallinity through annealing treatment (thermal annealing treatment). The preferred temperature (heating temperature) at annealing treatment is 165° C. or higher. The preferred heating time (retaining time) is varied in accordance with the heating temperature. When the heating temperature is 165° C. or higher, the preferred heating time is 5 seconds or more. A temperature drop rate at reducing a temperature from the heating temperature is preferably slower, more preferably is 30° C./min or less. However, if the heating time is enough time to annealing (in a case of 5 seconds or more), the temperature drop rate is particularly prescinded.

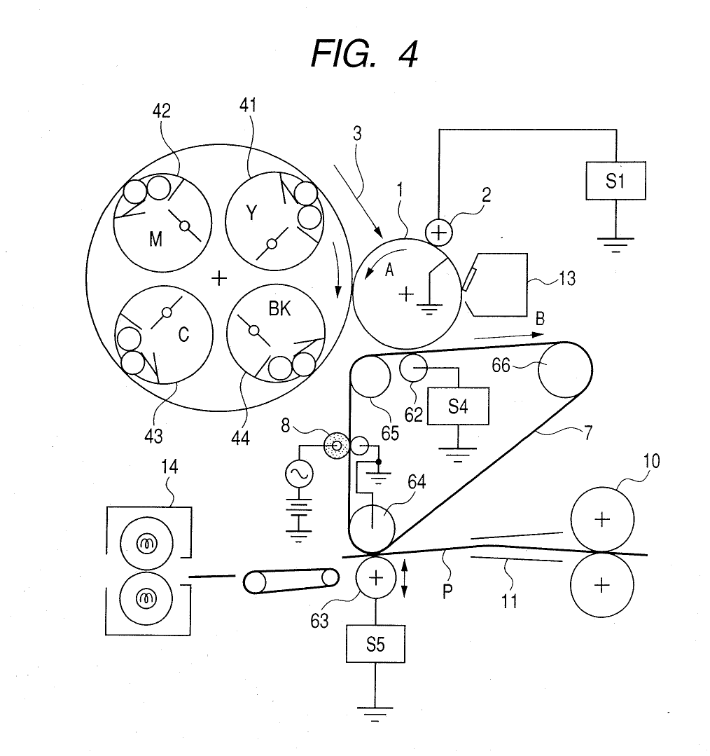

FIG. 4 is a diagrammatic explanatory drawing of an electrophotographic apparatus which employs an electrophotographic belt according to the present invention as an intermediate transfer belt.

Specifically, in FIG. 4, reference numeral 1 denotes a drum-shaped electrophotographic photosensitive member (hereinafter referred to as “photosensitive drum”), and is rotationally driven at a predetermined peripheral velocity in a direction shown by an arrow A. The photosensitive drum 1 is electrostatically charged into a predetermined polarity and a predetermined potential by a primary charging device 2 in a rotating process, and then is exposed to light 3 emitted from an image exposure device which is not illustrated. Reference character S1 denotes a power source of the primary charging device. Thus, an electrostatic latent image is formed which corresponds to a first color component of an objective color image (for instance, image by yellow component).

Subsequently, an electrostatic latent image is developed into an image of a yellow component which is a first color, by a first developing unit 41 (yellow developing unit). At this time, second, third and fourth developing units, namely, a magenta developing unit 42, a cyan developing unit 43 and a black developing unit 44 do not work, and do not act on a photosensitive drum 1. Accordingly, the magenta developing unit 42, the cyan developing unit 43 and the black developing unit 44 do not affect the image of the yellow component of the first color.

An intermediate transfer belt 7 is stretched so as to surround rollers 64, 65 and 66, is placed so as to contact with a photosensitive drum 1, and is rotationally driven in a direction shown by an arrow B at the same peripheral velocity as that of the photosensitive drum 1. Then, the image of the yellow component of the first color, which has been formed on the photosensitive drum 1, is primarily transferred onto the surface of the intermediate transfer belt 7, while passing through a nip part between the photosensitive drum 1 and the intermediate transfer belt 7. The image is primarily transferred through the action of an electric field formed by a primary transfer bias (of which the polarity is reverse to that of a toner), which is applied to a primary transfer roller 62 from a bias power supply S4.

A yellow toner remaining on a photosensitive drum 1 without being primarily transferred is cleaned by a cleaning unit 13. Subsequently, an image by a magenta toner of a second color, an image by a cyan toner of a third color and an image by a black toner of a fourth color are sequentially and superimposingly transferred onto an intermediate transfer belt, and thus an objective full color image is formed.

A full color image formed on an intermediate transfer belt 7 is secondarily transferred onto a transfer material (P). Specifically, the transfer material (P) is supplied from a cassette which is not shown, passes through a transfer material supply roller 10 and a transfer material guide 11, and is supplied to a nip part between the intermediate transfer belt 7 and a secondary transfer roller 63. At the same time, a secondary transfer bias is applied to the secondary transfer roller 63 from a bias supply S5, and thereby, the full color image formed on the intermediate transfer belt 7 is secondarily transferred onto the transfer material (P). The transfer material (P) having the full color image formed thereon is introduced into a fixing unit 14 to fix the full color image onto the transfer material (P).

On the other hand, a toner remaining on an intermediate transfer belt 7 without being transferred onto a transfer material in the secondary transfer step is electrostatically charged by an charging apparatus 8, is transferred to a photosensitive drum 1 in a nip part between the photosensitive drum 1 and the intermediate transfer belt 7, and is collected by a cleaning unit 13.

### EXAMPLE 1

A resin pellet was prepared by treating 82 parts by mass of PEEK (trade name “Victrex PEEK 381G” made by Victrex company) and 18 parts by mass of conductive carbon black (acetylene black with trade name “Denka Black” made by Denki Kagaku Kogyo), and a cylindrical film with a diameter of 230 mm was obtained by supplying the resin pellet to a single screw extruder, and melting and extruding the resin pellet by using a cylindrical die.

An endless belt (cylindrical film) with an average thickness of 100 μm was obtained by fitting the obtained cylindrical film into a cylindrical die, and annealing the film at 230° C. for five minutes to enhance the crystallinity of PEEK. In the annealing treatment, the temperature elevation rate was 100° C./min and the temperature drop rate was 200° C./min. In Example 2 and Comparative Example 2 described below, the same temperature elevation rate and temperature drop rate were employed.

The obtained endless belt was subjected to thermal analysis with the use of DSC, and then showed 0.5 J/g for the value at the peak of the crystallization exothermic heat ΔH of PEEK detected in a range of 150 to 200° C. The surface hardness of the obtained endless belt was also measured using a nanoindentation method, and showed 0.35 GPa. Furthermore, the provided endless belt was subjected to an MIT test specified in JIS P 8115, and showed the breaking number of 2,500 times and a fatigue limit stress of 35 MPa.

An endless belt obtained as described above was mounted on an electrophotographic apparatus using a two-component developer containing a magnetic carrier and a toner, as an intermediate transfer belt, and was subjected to a durability test. As a result of having output even 500,000 sheets of images, the intermediate transfer belt did not show a scratch due to a carrier and did not cause an image defect on the surface, and did not cause breakage in the edge part.

### EXAMPLE 2

An endless belt was prepared by the same method as in Example 1 except that the belt was annealed at 165° C. and for 10 seconds.

As to the endless belt prepared, the following results were obtained. The endless belt showed 9.0 J/g for the value at the peak of the crystallization exothermic heat ΔH of PEEK; the surface hardness of 0.25 GPa; and the fatigue limit stress of 30 MPa.

An endless belt obtained as described above was mounted on an electrophotographic apparatus using a two-component developer containing a magnetic carrier and a toner, as an intermediate transfer belt, and was subjected to a durability test. As a result of having output even 500,000 sheets of images, the intermediate transfer belt did not show a scratch due to a carrier and did not cause an image defect on the surface, and did not cause breakage in the edge part.

### COMPARATIVE EXAMPLE 1

An endless belt was prepared by the same method as in Example 1 except that the belt was not annealed.

As to the endless belt prepared, the following results were obtained. The endless belt showed 15 J/g for the value at the peak of the crystallization exothermic heat ΔH of PEEK; the surface hardness of 0.15 GPa; and the fatigue limit stress of 23 MPa.

An endless belt obtained as described above was mounted on an electrophotographic apparatus using a two-component developer containing a magnetic carrier and a toner, as an intermediate transfer belt, and was subjected to a durability test. As a result of having output 100,000 sheets of images, the intermediate transfer belt formed many scratches due to a carrier and caused an image defect, on the surface. As a result of subsequently continuing the durability test till outputting 150,000 sheets of images, the intermediate transfer belt caused a crack in the edge part in a cross direction.

### COMPARATIVE EXAMPLE 2

An endless belt was prepared by the same method as in Example 1 except that the belt was annealed at 155° C. and for 5 seconds.

As to the endless belt prepared, the following results were obtained. The endless belt showed 10 J/g for the value at the peak of the crystallization exothermic heat ΔH of PEEK; the surface hardness of 0.19 GPa; and the fatigue limit stress of 24 MPa.

An endless belt obtained as described above was mounted on an electrophotographic apparatus using a two-component developer containing a magnetic carrier and a toner, as an intermediate transfer belt, and was subjected to a durability test. As a result of having output 100,000 sheets of images, the intermediate transfer belt formed many scratches due to a carrier and caused an image defect, on the surface. As a result of subsequently having continued the durability test till outputting 200,000 sheets of images, the intermediate transfer belt caused a crack in the edge part in a cross direction.

As described above, the present invention can provide an intermediate transfer belt which hardly causes a scratch due to the carrier even when used in an electrophotographic apparatus with the use of a two-component developer containing a magnetic carrier and a toner, though being a single-layered structure.

The present invention can also provide an electrophotographic apparatus having the above described intermediate transfer belt. While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-157359, filed Jun. 6, 2006 and Japanese Patent Application No. 2007-141407, filed May 29, 2007, which are hereby incorporated by reference herein in their entirety.

What is claimed is:

1. An intermediate transfer belt of a single layer made from a resin composition including a crystalline thermoplastic resin and 5 parts by mass or more and 40 parts by mass or less of a conductive filler with respect to 100 parts by mass of the crystalline thermoplastic resin, wherein the surface hardness of the intermediate transfer belt is 0.25 GPa or higher and 0.60 GPa or lower when measured using a nanoindentation method.

2. The intermediate transfer belt according to claim 1, wherein the fatigue limit stress is 30 MPa or higher and 150 MPa or lower, which is determined from the conversion stress shown in the following expression (1) and a determination of folding endurance specified in JIS P 8115:
conversion stress=E×d/(4r+2d)+9.8M/(d×h) (1)
wherein d/(4r+2d) is 0.03 or less; E represents a Young's modulus of a sample with a film shape, which is collected from the intermediate transfer belt and is used for measuring the conversion stress; d represents a thickness of the sample; r represents a bending radius; M represents a load; and h represents a width of the sample.

3. The intermediate transfer belt according to claim 1, wherein the crystalline thermoplastic resin is polyetheretherketone.

4. The intermediate transfer belt according to claim 1, wherein the crystalline thermoplastic resin shows the peak of crystallization exothermic heat ΔH detected between 150° C. and 200° C. in an amount of less than 10 J/g, when subjected to the thermal analysis with the use of the differential scanning calorimetry (DSC).

5. An electrophotographic apparatus having an intermediate transfer belt, wherein the intermediate transfer belt is formed of a single layer which is made from a resin composition including a crystalline thermoplastic resin and 5 parts by mass or more and 40 parts by mass or less of a conductive filler with respect to 100 parts by mass of the crystalline thermoplastic resin, and has the surface hardness of 0.25 GPa or higher and 0.60 GPa or lower when measured using a nanoindentation method.

6. The electrophotographic apparatus according to claim 5, wherein the intermediate transfer belt has a fatigue limit stress of 30 MPa or higher and 150 MPa or lower, which is determined from the conversion stress shown in the following expression (1) and a determination of folding endurance specified in JIS P 8115: conversion stress=E×d/(4r+2d)+9.8M/(d×h) (1), wherein d/(4r+2d) is 0.03 or less; E represents a Young's modulus of a sample with a film shape, which is collected from the intermediate transfer belt and is used for measuring the conversion stress; d represents a thickness of the sample; r represents a bending radius; M represents a load; and h represents a width of the sample.

7. The electrophotographic apparatus according to claim 5, wherein the crystalline thermoplastic resin is polyetheretherketone.

8. The electrophotographic apparatus according to claim 5, wherein the crystalline thermoplastic resin in the intermediate transfer belt shows the peak of crystallization exothermic heat ΔH detected between 150° C. and 200° C. in an amount of less than 10 J/g, when subjected to the thermal analysis with the use of the differential scanning calorimetry (DSC).

9. The electrophotographic apparatus according to claim 5, which uses a two-component developer including a magnetic carrier and a toner, as the developer.

10. The electrophotographic apparatus according to claim 6, which uses a two-component developer including a magnetic carrier and a toner, as the developer.

11. The electrophotographic apparatus according to claim 7, which uses a two-component developer including a magnetic carrier and a toner, as the developer.

12. The electrophotographic apparatus according to claim 8, which uses a two-component developer including a magnetic carrier and a toner, as the developer.
